(19) United States
(12) Patent Application Publication
(10) Pub. No.: US 2026/0098513 A1
(43) Pub. Date: Apr. 9, 2026

(54) FLOW-THROUGH GENERATOR WITH MAGNETIC COUPLING FOR PIPELINE POWER GENERATION

(71) Applicant: Pneupower Generators Ltd., Fort ST. John (CA)

(72) Inventors: Mark Seward, St.John’s (CA); Alexander Gheseger, Calgary (CA)

(21) Appl. No.: 19/350,005

(22) Filed: Oct. 5, 2025

Related U.S. Application Data
(60) Provisional application No. 63/703,203, filed on Oct. 4, 2024.

(51) Int. Cl. F03B 13/02; F03B 3/02; F03B 11/00

(52) U.S. Cl. CPC F03B 13/02; F03B 3/02; F03B 11/006; F05B 2220/7068

(57) ABSTRACT

A pipeline-integrated power generation system for remote oil and gas sites is disclosed. The system utilizes a flow-through generator with contactless magnetic coupling to eliminate shaft seals and dynamic penetrations. The system comprises a pipeline with a flow restriction device creating pressure differential, branch and return lines routing pressurized fluid through the flow through generator, and a sealed housing defining pressurized and atmospheric portions separated by a non-magnetic generator wall. A turbine wheel, shaft, and permanent magnets operate within the sealed portion, while external windings in the unsealed portion generate electricity through magnetic coupling across the generator wall. The contactless design eliminates leak paths, reduces maintenance requirements, and provides zero-emission power generation from existing pipeline flow. The sealed, self-contained design minimizes maintenance and enhances durability, suitable for remote locations.

### REFERENCE TO RELATED APPLICATIONS

This application claims priority to U.S. Provisional Application No. 63/703,203, titled, “PIPELINE-INTEGRATED POWER GENERATION SYSTEM FOR REMOTE OIL AND GAS SITES”, filed October 4, 2024, the specification of which is hereby incorporated by reference in its entirety.

### BACKGROUND OF THE INVENTION

### Field of the Art

The disclosure relates to the field of inline generators in oil and gas pipelines, and more particularly to the field of turbine generators in pipelines for generating on-site power using fluid flow in the pipelines.

### Discussion of the State of the Art

Remote oil and gas production sites require reliable electrical power to operate critical equipment including control systems, monitoring devices, chemical injection pumps, and safety systems. These locations are typically situated far from electrical grid infrastructure, necessitating on-site power generation solutions. The harsh operating environment, combined with the need for continuous operation, presents significant technical challenges for conventional power generation systems.

Traditional inline power generation systems that attempt to harness pipeline fluid flow suffer from fundamental design limitations related to pressure containment and mechanical sealing. Conventional turbine-generator systems require rotating shafts to penetrate the pressure boundary of the pipeline, necessitating dynamic seals between the high-pressure internal environment and the external generator components. These shaft seals represent critical failure points that can lead to catastrophic loss of containment, environmental contamination, and significant safety hazards.

Dynamic sealing systems in high-pressure oil and gas applications are inherently problematic due to the combination of rotational motion, pressure differentials, and potentially corrosive fluid compositions. Seal failure modes include wear-induced leakage, chemical degradation, thermal cycling damage, and mechanical failure under pressure fluctuations. When seals fail in pipeline applications, the consequences extend beyond equipment damage to include environmental contamination, regulatory violations, and potential safety incidents involving personnel.

The mechanical complexity of conventional inline generators further compounds reliability issues at remote sites. External generator components, including bearings, couplings, and electrical systems, are exposed to environmental conditions and require regular maintenance access. The presence of multiple moving parts, external mechanical connections, and weather-exposed components creates numerous potential failure modes that can result in system downtime and costly maintenance interventions.

Further, maintenance accessibility represents a particularly acute challenge for remote oil and gas installations. These sites are often located in geographically isolated areas with limited transportation infrastructure, making routine maintenance visits expensive and logistically complex. Equipment failures requiring immediate attention can result in extended downtime while specialized personnel and replacement components are mobilized to remote locations. This maintenance burden is exacerbated by the need for specialized sealing systems and external mechanical components in conventional inline generator designs.

Energy efficiency considerations further limit the applicability of existing solutions. Many current approaches for remote power generation rely on external fuel sources, such as diesel generators or gas-fired engines, which consume valuable hydrocarbon resources and generate emissions. Solar and wind power systems, while environmentally favorable, suffer from intermittency issues and may not provide consistent power output under varying seasonal and weather conditions. The substantial pipeline fluid flow represents a significant untapped energy resource that could provide continuous, emission-free power generation.

Scalability presents additional technical challenges for pipeline power generation systems. Oil and gas pipeline infrastructure varies significantly in terms of pipe diameter, operating pressure, flow rates, and fluid composition. Existing inline generator designs often lack the flexibility to accommodate this wide range of operating parameters without extensive customization or complete system redesign. This limitation restricts the broader adoption of pipeline-based power generation across diverse operational contexts.

Furthermore, regulatory requirements for environmental compliance and safety in oil and gas operations have become increasingly stringent, particularly regarding emission reduction and leak prevention. Power generation systems that rely on combustion of hydrocarbons contribute to the overall carbon footprint of operations, while systems with dynamic seals and external components present ongoing risks of environmental contamination through seal failure or mechanical breakdown.

Therefore, there exists a significant need in the art for a pipeline-integrated power generation system that can safely and reliably harness the energy of flowing pipeline fluids without the inherent risks associated with dynamic sealing systems, while providing robust operation in remote environments with minimal maintenance requirements and adaptability to varying pipeline specifications and operating conditions.

### SUMMARY OF THE INVENTION

Accordingly, the inventor has conceived and reduced to practice, in a preferred embodiment of the invention, a pipeline-integrated power generation system that generates electrical power from pressurized fluid flow in oil and gas pipelines. The system addresses need for reliable, maintenance-free power generation at remote oil and gas sites while eliminating the safety and environmental risks associated with traditional shaft-sealed generator designs.

According to a preferred embodiment of the invention, a flow-through generator operates through contactless magnetic coupling, completely eliminating dynamic sealing surfaces and shaft penetrations through pressure boundaries. The system employs a pressure differential mechanism created by a flow restriction device positioned in the main pipeline, generating higher pressure upstream and lower pressure downstream. This pressure differential drives fluid through the generator via branch and return lines, enabling power generation without impacting overall pipeline flow.

According to a preferred embodiment of the invention, the flow-through generator comprises a sealed housing with two distinct environments: a sealed portion containing pressurized fluid and an unsealed portion at atmospheric pressure. These portions are separated by a non-magnetic generator wall that enables magnetic field transmission while maintaining complete pressure isolation. Within the sealed portion, pressurized fluid flow rotates a turbine wheel mechanically coupled to a shaft carrying permanent magnets. The rotating magnetic field generated by these magnets transmits through the non-magnetic generator wall to induce electrical current in external windings positioned in the unsealed portion.

According to a preferred embodiment of the invention, the contactless power transfer mechanism represents a paradigm shift from traditional penetration-based designs to a completely sealed approach. The elimination of dynamic seals and shaft penetrations removes the primary failure modes that plague conventional pipeline generators, providing zero-leakage operation essential for environmental compliance and operational safety.

According to a preferred embodiment of the invention, the system operates within industry-standard pressure ranges of 100-1440 PSIG and complies with ASME BPVC Section VIII Division 1 pressure vessel standards. The sealed housing design enables operation in hazardous environments rated Class I Zone 1, Group B, C, D, making it suitable for harsh oil and gas applications. The flow-through generator integrates with existing pipeline valves without requiring additional pipeline penetrations, minimizing installation complexity and infrastructure modifications.

According to a preferred embodiment of the invention, power conditioning is achieved through an integrated charge controller electrically connected to the external windings, with optional battery bank integration for energy storage. The inlet and outlet ports serve as the sole fluid connections to the sealed flow-through generator housing, maintaining system simplicity and reliability.

According to a preferred embodiment of the invention, the invention provides significant operational advantages including zero-emission power generation utilizing existing pipeline infrastructure, elimination of fugitive emissions through complete sealing, extended maintenance intervals due to contactless operation, and fail-safe characteristics inherent in magnetic coupling design. These features make the system particularly valuable for remote oil and gas installations where maintenance access is challenging, and environmental compliance is critical.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting the scope of the invention or the claims herein in any way.

FIG. 1 shows a system layout of a pipeline-integrated power generation system integrated into oil and gas pipelines, according to an embodiment of the invention;

FIG. 2A shows external side views of a flow-through generator, according to an embodiment of the invention;

FIG. 2B shows an exploded view of the internal components within flow-through generator, according to an embodiment of the invention.

FIG. 2C and 2D show the side and top view of the complete flow-through generator assembly, according to an embodiment of the invention;

FIG. 3A illustrates the architecture of a traditional shaft-sealed pipeline generator;

FIG. 3B illustrates the architecture of flow-through generator design, according to an embodiment of the invention;

FIG. 4 shows a detailed cross-sectional view (Section A-A) of the magnetic coupling mechanism, according to an embodiment of the invention;

FIG. 5 illustrates the contactless power generation mechanism of the flow-through generator, according to an embodiment of the invention; and

FIG. 6 is a flowchart describing a method for contactless power generation using flow-through generator according to an embodiment of the invention.

### DETAILED DESCRIPTION

The inventor has conceived, and reduced to practice, a novel power generation system integrated into oil and gas pipelines. This system is designed to produce electricity from the flow of effluent (oil and gas mixture) through the pipeline, providing a reliable power source for remote oil and gas sites without additional emissions.

One or more different inventions may be described in the present application. Further, for one or more of the inventions described herein, numerous alternative embodiments may be described; it should be appreciated that these are presented for illustrative purposes only and are not limiting the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

A description of an embodiment with several components in communication with each other does not imply that all such components are required. On the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any practical order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Flow-through generator” refers to a power generation device in which all rotating mechanical components operate continuously within a pressurized fluid environment, with power extraction occurring through magnetic coupling across a sealed barrier.

“Contactless power transfer” refers to the transmission of rotational energy from a pressurized internal environment to an atmospheric external environment through magnetic coupling across a non-magnetic barrier, without any physical connection between moving and stationary components.

“Generator wall” refers to a non-magnetic pressure barrier constructed of materials with lower magnetic permeability and serving dual functions as both pressure containment boundary and magnetic coupling interface between sealed and unsealed portions of the flow-through generator.

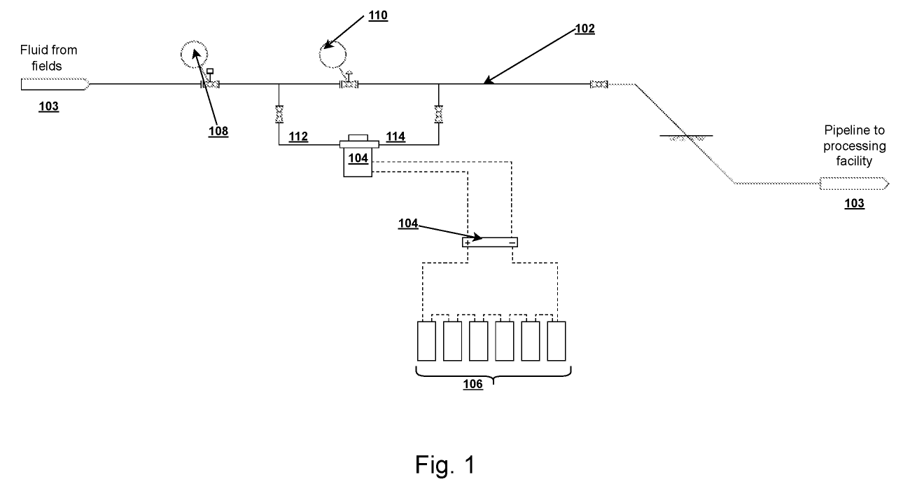

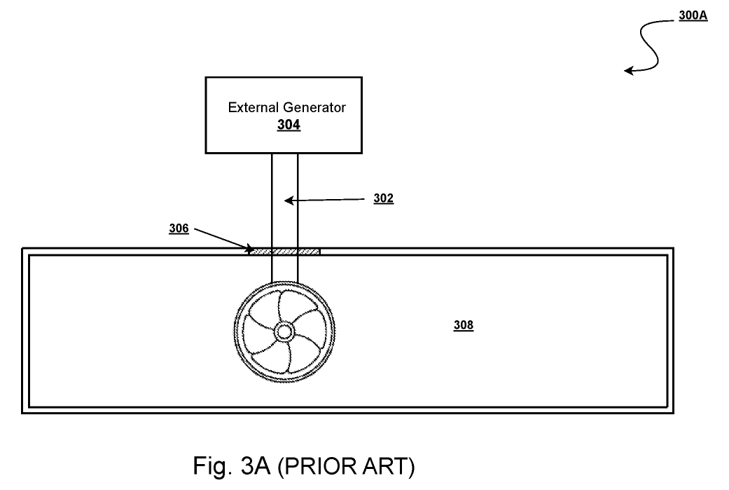

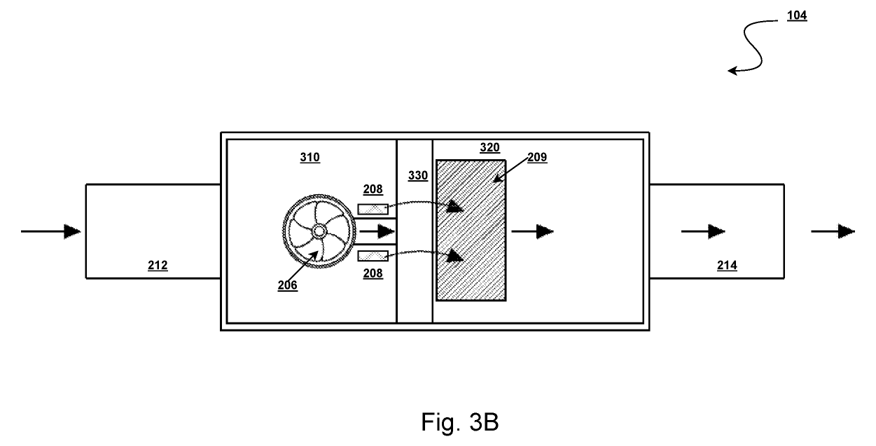

Referring now to FIG. 1, a system layout of the pipeline-integrated power generation system 100 according to an embodiment of the invention is disclosed. Unlike prior art systems that require rotating shafts to penetrate pressure boundaries with mechanical seals (as illustrated in FIG. 3A), the present invention eliminates all shaft penetrations and dynamic sealing surfaces through a sealed flow-through generator 104 that transfers power magnetically across a non-magnetic generator wall. This architectural innovation removes the primary failure modes—seal leakage, environmental contamination, and maintenance-intensive mechanical seals—that plague traditional pipeline generator designs, while maintaining power transfer efficiency across the sealed boundary.

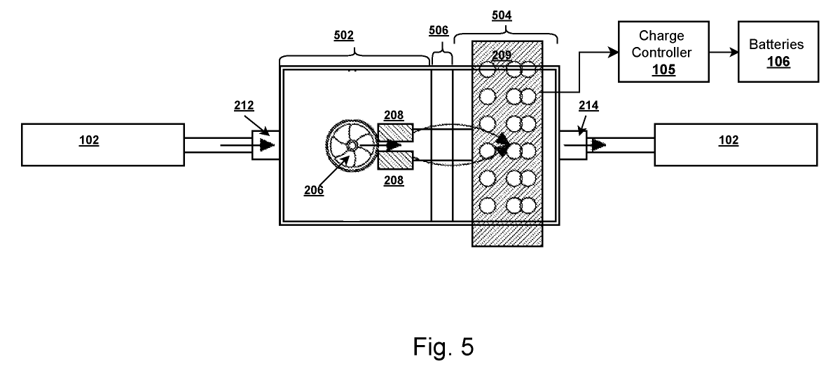

Pipeline-integrated power generation system 100 integrates into existing oil and gas pipeline infrastructure and operates on the principle of pressure differential extraction, utilizing existing energy stored in pressurized pipeline flow 101 to generate electrical power without requiring external energy input or creating emissions that would impact environmental compliance requirements. The contactless power generation mechanism enables complete hermetic sealing throughout operation, eliminating all fugitive emissions and providing fail-safe operation through inherent torque limiting in the magnetic coupling design. Contactless power generation is explained in detail the description and drawings of FIG. 5.

In an embodiment, pipeline 102 serves as the main conduit carrying oil and gas mixture 101 from production wells (fluid from fields) to downstream processing facility 103. This pipeline 102 typically operates within industry-standard specifications of 4 NPS (Nominal Pipe Size) or larger diameter, with operating pressures ranging from 100 to 1440 PSIG, conforming to either 300 or 600 ANSI pressure classifications as dictated by field conditions and regulatory requirements. Pipeline 102 forms the foundation of the entire power generation system, as it provides both the medium and the energy source for electricity production through the flowing pressurized fluid 101.

In an embodiment, a pressure differential mechanism is created to enable efficient energy extraction from pipeline flow 101 without significantly impacting the primary function of fluid transport. The pressure differential mechanism operates through a strategically positioned flow restriction device, which may take the form of an orifice plate, venturi tube, or engineered control valve 110. This restriction device creates a localized area of higher pressure upstream and correspondingly lower pressure downstream, with the pressure differential precisely controlled by adjusting the degree of restriction. In many implementations, pre-existing valves in pipeline 102 can be utilized for creating this restriction, thereby avoiding the need for new pipeline penetrations and minimizing installation complexity while maintaining system integrity. This pressure differential extraction approach allows the system to harness otherwise wasted pressure energy without impeding the primary transportation function of pipeline 102.

In an embodiment, pipeline-integrated power generation system 100 incorporates critical safety infrastructure through emergency shutdown valve (ESDV) 108, an actuated safety valve designed to immediately stop fluid flow upon detection of dangerous conditions. This valve 108 protects against potential harm to personnel, equipment, and the environment, ensuring that the power generation system operates within established safety protocols. The ESDV 108 represents an essential component that allows the power generation system to be integrated into existing pipeline safety management systems without compromising operational safety standards.

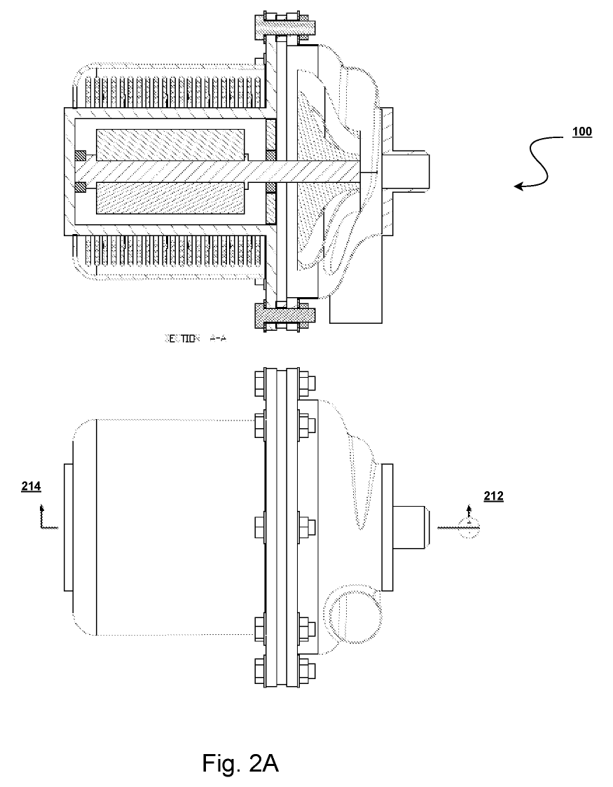

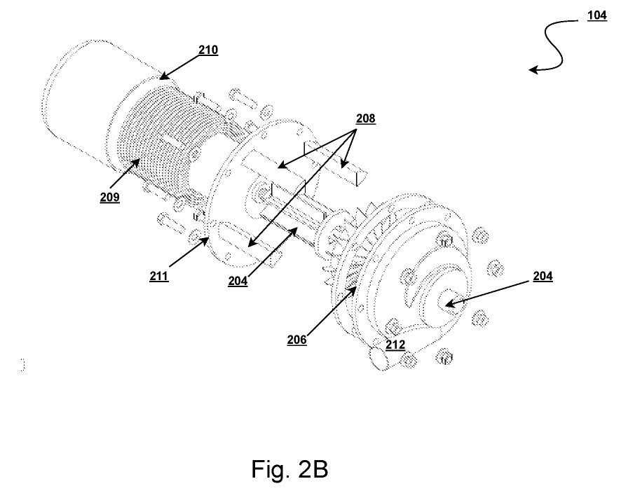

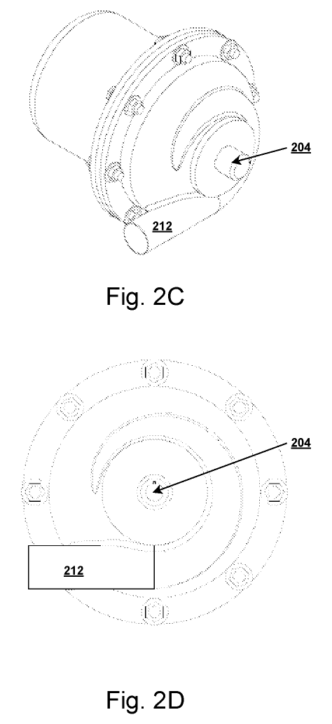

In an embodiment, pipeline-integrated power generation system 100 includes flow-through generator 104 positioned across pipeline 102 via the existing or engineered valve system. Flow-through generator 104 housing may be constructed of non-magnetic, pressure-resistant materials such as 316L stainless steel with magnetic permeability (μᵣ) less than 1.1, or specialized alloys that provide adequate wear resistance while maintaining the necessary strength to withstand pipeline operating pressures up to 1440 PSIG. The sealed design ensures that all moving components—including turbine wheel, shaft, and permanent magnets (shown in exploded view in FIG. 2B)—remain within the pressurized system boundary, eliminating potential leak paths that could compromise environmental compliance or operational safety.

In an embodiment, the internal architecture of flow-through generator 104 creates two distinct operational environments separated by a non-magnetic generator wall (illustrated in FIG. 5): a sealed portion containing pressurized fluid 101 with all rotating mechanical components, and an unsealed portion at atmospheric pressure containing external electrical windings. This separation enables contactless power transfer through magnetic coupling across the generator wall without any physical connection between moving and stationary components, thereby eliminating the mechanical seal failure modes inherent in traditional shaft-penetrating designs (comparative architecture shown in FIGS. 3A and 3B).

In an embodiment, branch line 112 serves as the high-pressure inlet connection, diverting a calculated portion of high-pressure flow from upstream of restriction device 110 directly to the generator inlet port 212 (shown in FIG. 2A). Branch line 112 may be sized to accommodate gas velocities typically ranging from 18 to 50 feet per second, ensuring optimal energy transfer while maintaining flow characteristics that support efficient turbine operation within the sealed portion of generator 104. The branch line 112 design incorporates appropriate valve arrangements and pressure instrumentation to enable system monitoring and control during operation, allowing the system to self-regulate based on available pipeline pressure and flow conditions.

Following power generation through the contactless magnetic coupling process, the processed fluid 101 is returned to main pipeline 102 through return line 114, which reconnects to the pipeline downstream of flow restriction device 110 via outlet port 214. This arrangement ensures continuous flow throughout the system while maintaining the pressure differential necessary for power generation. Return line 114 completes the flow circuit, allowing the system to operate as a bypass around restriction device 110 while extracting useful energy from the pressure drop, making the entire system a zero-emission power generation solution.

In an embodiment, the electrical power generated by flow-through generator 104 through electromagnetic induction in the external windings (3-phase, 36-slot stator configuration detailed in FIG. 2B) is conditioned and managed through charge controller 105.

In an embodiment, charge controller 105 is a power conditioning unit that provides essential functions including AC to DC rectification, voltage regulation, and battery protection algorithms. Charge controller 105 ensures that the variable power output from generator 104, which depends on pipeline flow conditions, is converted to stable, usable electrical energy suitable for charging battery systems and powering remote equipment. The charge controller enables continuous operation without maintenance intervention, automatically adjusting power output based on available flow conditions.

In an embodiment, battery bank 106 provides energy storage capability, ensuring continuous power supply to remote equipment even during periods of reduced pipeline flow or temporary system maintenance. Battery bank 106 may be sized based on the specific power requirements of the remote site and expected flow variability, providing reliable power for critical operations such as chemical injection pumps, monitoring equipment, and communication systems that are essential for safe remote oil and gas operations.

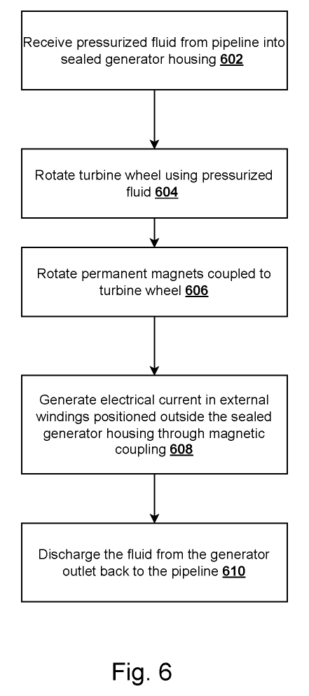

The flow-through generator 104 design eliminates all physical penetrations through pressure boundaries through its contactless magnetic coupling architecture, providing zero-emission power generation with inherent safety advantages compared to traditional generator systems that require shaft seals and dynamic mechanical connections. This innovative approach addresses the critical need for reliable, environmentally compliant power sources at remote oil and gas sites while leveraging existing infrastructure to minimize installation costs and environmental impact. The system's ability to operate within standard pipeline specifications (300 or 600 ANSI), its compatibility with existing safety systems including ESDV 108, and its capability for hot-tap installation without requiring pipeline shutdown make it a versatile solution for a wide range of operational contexts in the oil and gas industry. The complete isolation between pressurized fluid handling (sealed portion) and electrical power generation (unsealed portion) through the non-magnetic generator wall eliminates traditional failure modes associated with shaft penetrations through pressure barriers, enabling safe, maintenance-free operation with zero fugitive emissions from the pressurized system (contactless power generation process illustrated in FIG. 5 and method steps shown in FIG. 6).

FIG. 2A shows external side views of flow-through generator 104, according to an embodiment of the invention.

Flow-through generator 104 may be constructed as a complete pressure vessel with no mechanical connections between internal rotating components and external electrical systems. Flow-through generator 104 housing construction utilizes 316L stainless steel with wall thickness of approximately one-fourth inch (approx. 6mm) for the 2-3/8-inch diameter configuration, providing essential non-magnetic properties with magnetic permeability (μᵣ) less than 1.1, which is crucial for efficient magnetic coupling operation across the housing wall.

The external configuration incorporates two primary fluid connections that integrate seamlessly with existing pipeline infrastructure. Inlet 212 serves as the high-pressure fluid connection from branch line 112, designed to accommodate operating pressures up to 1440 PSIG while maintaining structural integrity under all anticipated operating conditions. The inlet design optimizes fluid entry into the internal turbine chamber, ensuring maximum energy extraction from the pressurized gas and liquid mixture flowing through the system. Correspondingly, outlet 214 provides the lower-pressure fluid discharge connection to return line 114, completing the flow circuit that allows processed fluid to return to the main pipeline downstream of the pressure restriction device.

Flow-through generator 104 assembly may be engineered as a sealed pressure vessel rated for 600 ANSI classification, fully complying with ASME Boiler and Pressure Vessel Code Section VIII Division 1 standards for pressure vessel construction and operation, ensuring compliance with relevant pipeline codes including ASME B31.X and CSA Z662. This design approach ensures that flow-through generator 104 may be safely integrated into existing pipeline systems without compromising safety standards or operational reliability. Flow-through generator 104 incorporates only static sealing surfaces utilizing torqued bolts and ASME standard spiral wound metallic gaskets, completely eliminating all dynamic sealing requirements that represent traditional failure modes in conventional generator designs. This innovative sealing approach removes the need for rotating shaft seals, providing extended maintenance intervals and enhanced safety characteristics particularly valuable for remote oil and gas operations where frequent maintenance access is challenging and costly. The torque-limiting nature of the magnetic coupling provides inherent fail-safe characteristics, while the elimination of shaft seals removes the single largest point of failure in traditional generator designs.

The environmental rating of the system demonstrates its suitability for harsh oil and gas operating conditions, designed specifically for Class I Zone 1, Group B, C, D hazardous area installation with explosion-proof certification. The sealed pressure vessel and wetted components are constructed of materials suitable for sour gas service with H2S concentrations up to 10,000 ppm in the process fluid (while the external components operate in standard atmospheric conditions) and function reliably across an operating pressure range of 100-1440 PSIG and temperature range from -40°F to +140°F, with process fluid flow providing the primary means of thermal management. The system tolerates both sweet and sour gas compositions as well as various liquid types, ensuring consistent performance under the extreme conditions commonly encountered in remote oil and gas sites.

FIG. 2B shows an exploded view of the internal components within flow-through generator 104, according to an embodiment of the invention. This internal assembly architecture represents a departure from traditional generator designs, as it eliminates any exposure of rotating components to external environmental factors that could cause contamination, corrosion, or mechanical wear.

The central component of the internal assembly is turbine wheel 206, which features a disc configuration with specially angled blades optimized for maximum fluid flow efficiency. Turbine wheel 206 design may be engineered to extract maximum energy from the pressurized gas and liquid mixture as it flows from inlet 212 through the flow-through generator 104 chamber to outlet valve. The blade geometry and surface finish may be optimized to minimize turbulence while maximizing energy transfer from the flowing fluid to the rotating assembly, ensuring efficient power generation across a wide range of flow conditions.

In an embodiment, shaft 204 is the central rotating element that mechanically connects turbine wheel 206 to the magnetic assembly, transmitting rotational energy generated by fluid flow 101 from wells to the power generation components. Shaft 204 may be equipped with precision bearings designed for high-speed operation while remaining completely enclosed within the sealed housing environment. This shaft 204 design eliminates the traditional requirement for dynamic seals that penetrate the pressure boundary, representing a significant advancement in generator reliability and safety.

In an embodiment, the magnetic power transfer system centers around permanent magnets 208, which are arranged in a specific alternating north-south pole configuration around shaft 204, where the first magnet has its North pole-oriented outward, the second has its south pole outward, and so forth in the same arrangement as a permanent magnet generator. These rare earth permanent magnets provide the magnetic field strength necessary for efficient power transmission through the sealed 316 stainless steel housing wall. Rotor 211 serves as the magnetic assembly housing that contains the permanent magnets and rotates within the sealed vessel in direct response to turbine operation, creating a rotating magnetic field that extends through the non-magnetic housing material to interact with external electrical components.

External windings 209 consist of a carefully arranged copper conductor assembly positioned outside the sealed housing, configured as a 3-phase, 36-slot stator 210 assembly that generates electrical current through electromagnetic induction. As turbine wheel 206 rotates driven by fluid flow 101, it causes shaft 204 and attached magnets 208 to spin within the sealed container. The rotating magnetic field produced by these spinning magnets induces electrical current in the external windings 209, effectively generating electricity without any physical connection between the moving and stationary components of the flow-through generator 104. This magnetic coupling mechanism enables power transfer from internal pressurized components to external atmospheric components maintained through the housing wall. The rotating magnets 208 are positioned with a radial clearance of approximately 1-3mm from the inner surface of generator wall 506, while external windings 209 are positioned with approximately 1-3mm radial clearance from the outer surface of generator wall 506, creating a total magnetic air gap (excluding the 6mm wall thickness) of approximately 2-6mm. This arrangement provides efficient magnetic field transmission while preserving complete pressure isolation and allowing for thermal expansion and mechanical tolerances during operation.

The specific electrical design parameters for external windings 209 and stator assembly 210, including a number of winding turns, wire gauge, winding configuration, and magnetic circuit optimization, would be readily determined by one of ordinary skill in the art of electrical generator design based on the desired voltage output, expected rotational speeds derived from pipeline flow conditions, and the magnetic field strength of permanent magnets 208. Standard electromagnetic design principles for permanent magnet generators apply once the physical architecture of sealed portion 502, unsealed portion 504, and generator wall 506 is established. The invention resides in the contactless magnetic coupling architecture across the pressure boundary, not in the particular electromagnetic design choices, which follow conventional generator engineering practices.

By way of non-limiting example, in one embodiment configured for operation at 400 PSIG pipeline pressure with approximately 75 ft³/min gas flow through a 2-3/8 inch diameter flow-through generator 104, the system employs a 3-phase stator assembly 210 with 36 slots containing copper windings 209, each coil comprising approximately 180-220 turns of 18 AWG magnet wire wound in a distributed winding pattern. Permanent magnets 208 comprise eight neodymium rare-earth magnets (N42 grade) arranged in alternating north-south pole configuration around shaft 204, each magnet measuring approximately 1 inch in length with 0.5-inch width and 0.25-inch thickness, providing the specified magnetic flux density of 12,000-15,000 Gauss at the air gap. Under these conditions, with turbine 206 rotating at approximately 3,000-3,600 RPM driven by the pressure differential, the system generates three-phase AC power at approximately 28-32 volts RMS, which is then rectified and regulated by charge controller 105 to provide 24-28 VDC output at up to 20 amperes for battery charging or direct equipment operation. This exemplary embodiment demonstrates the practical implementation of the contactless magnetic coupling principle, though one skilled in the art would readily understand that the electrical parameters can be scaled and optimized for different pipeline operating conditions, desired voltage outputs (12V, 24V, 48V systems), and power requirements ranging from 100W to 25kW through appropriate selection of magnet strength, winding configurations, turbine sizing, and stator geometry while maintaining the core architectural principle of sealed pressure vessel operation with contactless power transfer across generator wall 506.

In an embodiment, flow monitoring is achieved through a magnetic pickup sensor system that counts pulses as the device rotates, allowing flow rate to be accurately inferred from the pulse rate, while pressure and temperature monitoring utilizes commercially available sensors compatible with the operating range of 100-1440 PSIG and -40°F to +140°F.

FIG. 2C and 2D show the side and top view of the flow-through generator 104 assembly. These orthographic views reveal how inlet 212 is strategically positioned for optimal flow entry into the internal turbine chamber, ensuring maximum energy extraction from the pressurized fluid as it enters the sealed vessel. Shaft 204 is centrally located within the housing configuration to provide balanced rotation characteristics and facilitate efficient magnetic coupling between the internal rotating magnetic assembly and external stationary electrical components. The cylindrical housing geometry represents an optimized design approach that simultaneously addresses the dual requirements of pressure containment under high-pressure pipeline operating conditions and effective magnetic field transmission through the non-magnetic housing wall to external electrical generation equipment.

The installation characteristics demonstrated in these views highlight the flow-through generators 104 suitability for hot-tap installation procedures, which enable deployment without requiring pipeline shutdown, thereby minimizing operational disruption and installation costs while maintaining system safety and integrity throughout the installation process. The compact form factor illustrated in the side and top views allows flow-through generator 104 to be integrated through existing pipeline valve openings, significantly reducing the need for extensive infrastructure modifications or additional pipeline penetrations that would complicate installation and potentially compromise system integrity. The maintenance advantages inherent in this sealed design configuration are clearly apparent from these views, as all internal components remain completely protected from external environmental factors including dust, debris, weather conditions, and corrosive atmospheres that commonly affect conventional external power generation equipment. The continuous fluid flow through the sealed system provides natural lubrication for all moving components while creating a self-cleaning action that prevents the buildup of deposits or debris that could impair performance over extended operating periods, contributing to significantly extended maintenance intervals and reduced overall maintenance costs that make the system particularly valuable for remote oil and gas installations where frequent maintenance access would be logistically challenging and prohibitively expensive.

FIGS. 3A and 3B provide a critical architectural differentiation between traditional shaft-sealed pipeline generators 300A representing prior art and the present invention's flow-through generator 104 approach. FIG. 3A demonstrates the inherent limitations of prior art shaft-sealed systems, which utilize a physical shaft 302 penetrating the pressure boundary and requiring a mechanical seal 306 at the penetration point. This architecture creates multiple inherent leak paths through the shaft seal interface, which represents a dynamic sealing surface subject to continuous wear and eventual failure under harsh pipeline operating conditions. The physical penetration through the pressure boundary requires regular maintenance access and creates a direct mechanical connection between the pressurized pipeline 308 environment and the atmospheric generator environment, with external generator 304 components remaining exposed to environmental conditions and requiring frequent maintenance interventions.

FIG. 3B depicts the advantages of the present invention's flow-through generator 104 design, which completely eliminates the penetration-based architecture through a sealed pressure vessel that incorporates only inlet 212 and outlet 214 connections with zero shaft penetrations through the pressure boundary. All moving parts including the internal turbine 206 operate continuously within a sealed pressurized fluid environment 310, while magnetic power transfer enables contactless coupling occurs in the unsealed portion 320 across the sealed vessel wall 330, providing zero leak potential through the elimination of all dynamic sealing surfaces or penetrations through the pressure boundary. This represents a paradigm shift from penetration-based to flow-through-based power generation, where the internal turbine 206 operates continuously within the pressurized fluid environment while power extraction occurs through magnetic coupling across the sealed barrier, eliminating all mechanical seal failure modes that plague prior art systems. More details related to the contactless power generation, flow-through generator 104, and overall pipeline-integrates power generation system 100 is described in FIG. 5.

The advantages demonstrated by this comparison illustrate how the present invention eliminates seal replacement costs, environmental compliance risks associated with fugitive emissions, maintenance downtime, and safety hazards associated with traditional shaft-sealed systems. While conventional systems require regular dynamic seal maintenance and suffer from environmental exposure of critical components, the present invention provides maintenance-free operation through its completely sealed design approach, making it particularly valuable for remote oil and gas installations where maintenance access is challenging and costly.

The system's leak-proof design eliminates environmental compliance risks associated with fugitive emissions that plague traditional shaft-sealed systems, while the contactless magnetic coupling maintains power transfer efficiency across pressure boundaries without the mechanical wear and failure modes of conventional sealed shaft systems. The internal power generation assembly operates continuously in the pressurized fluid environment, eliminating the complex shaft penetrations, mechanical seals, and external generator mounting requirements of prior art systems. This fundamental architectural difference provides inherent advantages in safety, maintenance, and environmental compliance that cannot be achieved through incremental improvements to traditional shaft-sealed pipeline generator designs.

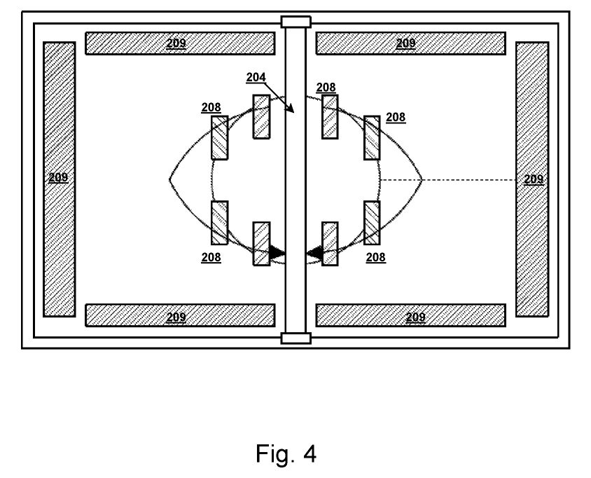

FIG. 4 shows a detailed cross-sectional view (Section A-A) of the magnetic coupling mechanism, showing the precise arrangement of permanent magnets 208 around shaft 204 and their relationship to external stator windings 209 positioned outside the non-magnetic pressure housing. The internal magnetic assembly consists of permanent magnets 208 arranged in alternating north-south pole configuration around central shaft 204, with the magnets mounted in a rotor assembly that rotates within the sealed pressure boundary. The magnetic field strength of 12,000-15,000 Gauss is maintained across the air gap, while shaft 204 serves as the central rotating element transmitting turbine power to the magnetic assembly.

The external stator assembly features stator windings 209 positioned outside the pressure housing at atmospheric pressure, with radial clearances totaling approximately 2-6mm (excluding the 6mm wall thickness) maintained between the rotating magnets 208 and stationary windings 209 to optimize magnetic coupling while accommodating thermal expansion and manufacturing tolerances. The magnetic flux lines cross the non-magnetic housing wall without physical contact, and the housing diameter is optimized for maximum magnetic coupling efficiency. The system demonstrates several critical engineering parameters, including torque transmission capabilities of up to 500 ft-lbs. through magnetic coupling and power transfer efficiency of up to 98% across the sealed boundary.

The non-magnetic housing constructed from 316L stainless steel maintains magnetic permeability below 1.1, while the magnetic coupling provides inherent torque limiting for overspeed protection, creating fail-safe operation characteristics. The cross-section demonstrates the precision requirements necessary for maintaining optimal air gap, proper magnet positioning, and housing concentricity required for efficient magnetic power transfer while preserving complete pressure isolation between the internal pressurized environment and external atmospheric conditions.

FIG. 5 illustrates the contactless power generation mechanism of flow-through generator 104, according to an embodiment of the invention. FIG. 5 shows the distinction between sealed portion 502 and unsealed portion 504 separated by the generator wall 506. In an embodiment, flow-through generator 104 includes a sealed portion 502 containing pressurized components (turbine) and an unsealed portion 504 operating at atmospheric pressure, with contactless power transfer occurring through generator wall 506.

In an embodiment, sealed portion 502 may operate within the pressurized environment and contains turbine 206, shaft 204, and permanent magnets 208. Pressurized fluid enters through inlet 212, flows through the internal chamber driving turbine 206, and exits through outlet 214. All components within this sealed portion 502 are immersed in the pressurized oil and gas mixture, with the rotating magnetic assembly generating the changing magnetic field necessary for power generation.

In an embodiment, generator wall 506 may be made of non-magnetic material. For example, generator wall 506 may be constructed using 316L stainless steel with approximately one fourth inch thickness. Generator wall 506 is placed as pressure separation barrier between the sealed pressurized portion 502 and the unsealed atmospheric portion 504. This non-magnetic wall maintains complete pressure isolation while allowing magnetic field transmission across the radial air gaps (approximately 2-6mm total, excluding wall thickness). The wall eliminates all physical penetrations that would compromise pressure integrity, representing the key innovation that enables contactless power transfer.

In an embodiment, the unsealed portion 504 operates at atmospheric pressure and contains external windings 209 positioned around the generator wall 506. These external windings 209 are completely isolated from the pressurized fluid environment, generating electrical current through electromagnetic induction as the magnetic field from the sealed portion crosses through the generator wall 506. The atmospheric environment allows for normal electrical connections and maintenance access to the power generation components.

During operation, power transfer occurs through magnetic coupling across the generator wall 506 without any physical connection between sealed 502 and unsealed portions 504. The rotating permanent magnets 208 within the sealed portion 502 create a changing magnetic field that penetrates the non-magnetic generator wall 506, inducing electrical current in the external windings 209 within the unsealed portion 504. This wall-based magnetic coupling eliminates traditional shaft penetrations and associated mechanical seals, providing zero-leakage operation while maintaining efficient power transfer.

The final step of the contactless power transfer involves conditioning the generated AC power through charge controller 105, which provides rectification to DC for battery charging or direct equipment power supply, enabling continuous operation without maintenance intervention. The contactless power generation mechanism provides significant operational advantages including zero leak paths through complete hermetic sealing that eliminates fugitive emissions, contactless operation that prevents mechanical wear between pressure environments, self-regulating characteristics where power output automatically adjusts to pipeline conditions, and fail-safe operation through inherent torque limiting provided by the magnetic coupling mechanism.

Technical parameters demonstrate the method's robust operational capabilities with operating pressure ranging from 100-1440 PSIG for continuous operation, temperature range from -40°F to +140°F without performance degradation, power requirements ranging from 100W to 25kW through appropriate scaling of generator diameter, magnet configurations, and turbine sizing based on flow conditions, and magnetic coupling efficiency of up to 98% across the sealed boundary. This process advantageously presents a novel completely contactless power transfer from pressurized pipeline fluid to atmospheric electrical generation equipment, eliminating all traditional mechanical seal failure modes while maintaining high efficiency power generation.

The sealed generator housing eliminates all shaft penetrations through pressure boundaries and utilizes static sealing surfaces exclusively, eliminating all dynamic sealing requirements and associated wear-prone components. This design provides zero environmental emissions through complete pressure containment, eliminating fugitive emissions and environmental compliance risks while operating safely in explosive atmospheres without ignition risk from moving seals. The contactless magnetic coupling mechanism provides inherent torque limiting for overspeed protection and fail-safe operation, while the hermetically sealed pressure vessel withstands full pipeline operating pressure without mechanical penetrations, ensuring extended service life and reliable operation in remote locations without frequent maintenance access.

### Process Method - Sealed to Unsealed Power Transfer

FIG. 6 is a flowchart describing a method for contactless power generation using flow-through generator 104. In the flow-through generator 104 power is transferred from the sealed pressurized environment 502 to the unsealed atmospheric environment 504 through the generator wall 506.

The process begins at step 602 where pressurized fluid from inlet 212 is received in within the sealed portion 502. At steps 604 and 606, pressurized fluid drives turbine 206, causing shaft 204 and attached magnets 208 to rotate within the pressurized environment. Turbine 206 operates continuously in pressurized environment without requiring connection of external components. Turbine rotation drives permanent magnets 208 around shaft 204. This sealed environment operation ensures all moving mechanical components remain within the pressure-contained space, eliminating exposure to atmospheric conditions and external contaminants.

At step 608, a rotating magnetic field generated within the sealed portion 502 transmits through generator wall 506 to the unsealed portion 504. The 316L stainless steel wall, being non-magnetic with thickness of approximately one-fourth inch, allows magnetic field transmission while maintaining complete pressure separation. The magnetic flux lines cross the wall through the 3-5mm air gap without requiring physical penetration or mechanical connections.

Power generation occurs within the unsealed portion 504 as external windings 209 positioned around the generator wall 506 generate electrical current through electromagnetic induction. Operating at atmospheric pressure, these windings 209 convert the transmitted magnetic field into three-phase electrical power, which is then conditioned through charge controller 105 for battery charging or direct equipment operation.

At step 610, the fluid from flow-through generator 104 is returned back to pipeline 102. This method provides complete isolation between pressurized fluid handling (sealed portion) and electrical power generation (unsealed portion), eliminating traditional failure modes associated with shaft penetration through pressure barriers. Generator wall 506 serves as both the pressure containment boundary and the magnetic coupling interface, enabling safe, maintenance-free operation with zero fugitive emissions from the pressurized system.

The method operates entirely within a pressurized environment isolated from atmospheric conditions for the rotating components, while the external power collection assembly remains at atmospheric pressure during all operating conditions. The generating process produces three-phase alternating current through electromagnetic induction, with electrical current conditioning available for battery charging or direct equipment power supply. The method eliminates all fugitive emissions by maintaining hermetic sealing throughout operation and returns fluid to the pipeline at reduced pressure for continued transport, ensuring zero dynamic sealing components subject to wear or failure.

The system provides continuous operation without maintenance requirements for mechanical seals, eliminating maintenance downtime associated with mechanical seal replacement while self-regulating power output based on available pipeline pressure and flow conditions. Installation advantages include configuration for integration with existing pipeline valves without requiring additional pipeline penetrations, utilization of existing pipeline infrastructure to minimize installation requirements, and enablement of hot-tap installation without pipeline shutdown requirements. The system integrates with existing safety shutdown systems without compromising pressure integrity and provides power generation proportional to pipeline flow rates and pressure differentials.

What is claimed is:

1. A pipeline-integrated power generation system comprising:
a pipeline carrying pressurized fluid flow;
a flow restriction device positioned in said pipeline creating a pressure differential with higher pressure upstream and lower pressure downstream;
a branch line to connect pipeline upstream of the flow restriction device to an inlet port of a flow-through generator;
a return line to connect an outlet port of the flow-through generator to pipeline downstream of the flow restriction device;
the flow-through generator comprising:
a sealed housing defining a sealed portion containing pressurized fluid and an unsealed portion at atmospheric pressure;
a non-magnetic generator wall separating the sealed portion from the unsealed portion;
a turbine wheel positioned within the sealed portion;
a shaft mechanically coupled to a turbine wheel;
permanent magnets coupled to the shaft and positioned within the sealed portion;
wherein responsive to receiving pressurized fluid flow in the sealed portion, the turbine wheel rotates and power is generated across the external windings, wherein contactless power transfer occurs through magnetic coupling between the permanent magnets and the external windings across the generator wall, wherein the external windings are positioned within the unsealed portion adjacent to the generator.

2. The system of claim 1, wherein the flow-through generator operates within pressure ranges of 100-1440. PSIG.

3. The system of claim 1, wherein the sealed housing eliminates dynamic sealing surfaces and shaft penetrations through pressure boundaries.

4. The system of claim 1, wherein the flow restriction device comprises one of an orifice plate, a venturi tube, or an engineered control valve.

5. The system of claim 1, wherein the pipeline-integrated power generation system further comprises a charge controller electrically connected to the external windings for conditioning generated electrical power.

6. The system of claim 1, wherein the pipeline-integrated power generation system further comprises a battery bank electrically connected to the charge controller for energy storage.

7. The system of claim 1, wherein the inlet port and the outlet port are the sole fluid connections to the sealed generator housing.

8. The system of claim 1, wherein said system is configured for integration with existing pipeline valves.
